(19) United States
(12) Patent Application Publication
(10) Pub. No.: US 2004/0043803 A1
(43) Pub. Date: Mar. 4, 2004

(54) Thresher rotor

(76) Inventors: Trevor Lundstrom, Kewdale (AU); David Lundstrom, Yokine (AU)

Correspondence Address: GREENBLUM & BERNSTEIN, P.L.C., 1950 ROLAND CLARKE PLACE, RESTON, VA, 20191, US

(21) Appl. No.: 10/311,360

(22) PCT Filed: Jun. 8, 2001
(86) PCT No.: PCT/AU01/00688

(30) Foreign Application Priority Data
Jun. 9, 2000 (AU) PO8083

(51) Int. Cl. A01F 12/00

(52) U.S. Cl. 460/59

(57) ABSTRACT

A threshing machine and an improved thresher rotor (10) therefor, the rotor having a central rotor tube (12), a plurality of radially extending annular collars (14) spaced therealong, and peripheral reinforcing bars (16) extending along the collars (14). Apertures (26) positioned adjacent the periphery (22) and similarly adjacent the reinforcing bars (16) receive elongate rods (28) therethrough along the length of the rotor (10). The elongate rods (28) retain a desired number of blades (32) in a pivotal manner, within annular channels (34) formed between the annular collars (14). The reinforcing bars (16) are positioned forward in rotation with respect to the elongate rods (28) in a manner allowing the reinforcing bars (16) to function as a heel for the blades (32).

### FIELD OF THE INVENTION

The present invention relates to an improved thresher rotor. More particularly, the improved thresher rotor of the present invention is intended to allow ready adaptation and alteration of blade arrangements thereon. Further, the improved thresher rotor is specifically adapted to allow efficient mulching of a wide range of crops.

### BACKGROUND ART

Threshing or mulching machines of the type typically towed behind a tractor or similar vehicle, including flail mowers or mulchers, generally comprise a rotor extending transversely to the direction of travel. This rotor will generally have one blade or flail per circumference of the rotor, the blades being staggered or offset around the rotor to maintain rotor balance. Whilst they are offset, the blades overlap each other to some extent across the transverse width of the rotor. Whilst there are differing blade shapes, differing rotor and cutting tip diameters, together with differing cutting chamber and counter-blade designs, these aspects are common.

Each blade provided on the rotor of prior art mulchers is typically provided within a pair of brackets through which the blade is bolted in a manner allowing the blade to pivot about a transverse axis. As this method of attachment is cumbersome there has been a reluctance to provide greater number of blades on rotors of prior art machines. The provision of the single blade per circumference impacts upon the speed and efficiency of mulching, particularly in broad acre crops. However, additional blades have typically not been used due to the reluctance to provide additional blade mounts due to cost and difficulty of construction, together with the cumbersome nature of blade changing as a consequence. In addition, typical rotors would not be expected to cope with the horsepower requirements to drive a rotor bearing greater number of blades as this would require a substantial rigidity in the rotor. Further, rotor speed is important in particular types of crops, particularly voluminous and tough crops, including rice.

Prior art mulching machines are unable to work effectively in certain crops, including rice stubble. Rice stubble has been found to be very dense and extremely tough. Attempts to mulch crops of this nature results in a phenomenon referred to as “wrap around”. As the blades of the mulching machine tend not to cut through the stubble material cleanly this results in tough strands wrapping around and building up around the blades. This obviously reduces cutting efficiency and will lead eventually to the stalling of the tractor towing the machine. It is a characteristic of rice stubble that it is quite green and generally continues to grow and toughen after it has been harvested. Consequently, mulching is much more difficult to achieve than in other cereal stubble crops.

Throughout the specification, unless the context requires otherwise, the word “comprise” or variations such as “comprises” or “comprising”, will be understood to imply the inclusion of a stated integer or group of integers but not the exclusion of any other integer or group of integers.

### DISCLOSURE OF THE INVENTION

In accordance with the present invention there is provided an improved thresher rotor comprising a rotor tube about the length of which is provided a plurality of radially extending annular collars in spaced relationship, adjacent said collars defining therebetween an annular channel, the collars having provided therein apertures through which are provided elongate rods.

Preferably, the rods are spaced preferably equidistantly around the collars substantially adjacent a periphery thereof. In a preferred form of the invention eight rods are provided in such a manner.

Still preferably, a plurality of reinforcing bars are provided spaced preferably equidistantly around the annular collars along the periphery thereof, in a manner offset with respect to the apertures through which are received the rods. In a preferred form of the invention eight reinforcing bars are also provided.

Still preferably, the rods have provided thereabout a plurality of blades located in the annular channels between the collars, the blades being retained in a pivotal manner. The blades are still preferably arranged so that they may project radially beyond the periphery of the annular collars. In a preferred form of the invention, four blades are provided in each annular channel defined by the collars, the blades being spaced evenly or equidistant. Still further, the blades in adjacent annular channels are preferably offset by 45°.

The rods may be releasably located or positioned through the apertures in the annular collars. As such, an annular rod retaining plate may be provided at each end of the rotor, releasably attachable to the outermost annular collar so as to capture the rods in their position through the annular collars. Removal of the annular rod retaining plate thereby allows removal of the rods and the changing of the blades held thereby.

In accordance with the present invention there is further provided a threshing machine comprising in part a thresher rotor as described hereinabove. The thresher rotor is provided within a mulching chamber, the mulching chamber having a forward wall comprised in part of a counter-blade provided at a lower edge thereof.

Preferably, the forward wall of the mulching chamber maintains a specific clearance from the blades of the thresher rotor so as to allow passage of the threshed material therethrough, the forward wall commencing at its lower edge at a point marginally below the axis of the thresher rotor and extending upwardly to a point forward of the vertical relative to that same axis.

Preferably the clearance from the blades lies between 10 mm and 50 mm.

Preferably the clearance from the blades lies between 15 mm and 30 mm.

Preferably the clearance from the blades lies between 18 mm and 25 mm.

The mulching chamber preferably has provided therein airflow passages projecting from an air intake to a point above the forward wall of the chamber at which point the airflow creates a venturi-flow with threshed material from the mulching chamber to discharge same therefrom. Still further, the mulching chamber preferably has a lid provided thereover, preferably pivotally mounted, the lid when in the open position or removed, allowing free discharge of threshed material from the mulching chamber to a point clear of the threshing machine. It also may be partially closed to direct loose voluminous material to the ground directly behind the machine. Further still, the lid is also an important safety feature.

The threshing machine further preferably comprises a clutch means for engaging and disengaging drive to the rotor. The rotor drive is preferably provided in the form of a belt or chain drive, the clutch means comprising at least in part an idler wheel able to be moved in a manner to either cause or releasing engagement of the belt or chain with a sprocket or similar provided on a shaft of the rotor.

### BRIEF DESCRIPTION OF THE DRAWINGS

The present invention will now be described, by way of example only, with reference to one embodiment thereof and the accompanying drawings, in which:

FIG. 1 is a schematic side elevational view of an improved thresher rotor and threshing machine in accordance with the present invention;

FIG. 2 is a perspective view of the improved thresher rotor of FIG. 1;

FIG. 3 is an exploded view of the improved thresher rotor of FIGS. 1 and 2;

FIG. 4 is a schematic representation of a blade arrangement on the improved thresher rotor of FIGS. 1 to 3 in which there is provided 3 blades per annular channel or circumference;

FIG. 5 is a schematic representation of the improved thresher rotor of FIGS. 1 to 3 in which there are provided 4 blades per annular channel or circumference;

FIG. 6 is schematic representation of the improved thresher rotor of FIGS. 1 to 3 in which there is provided 1 blade per annular channel or circumference;

FIG. 7 is a schematic representation of the improved thresher rotor of FIGS. 1 to 3 in which there are provided 2 blades per annular channel or circumference;

FIG. 8 is a schematic side elevational view of the improved thresher rotor and threshing machine of FIG. 1, showing airflow therethrough;

FIG. 9 is an upper perspective view of the forward wall of the mulching chamber together with airflow passages defined thereby; and

FIG. 10 is a schematic side elevational view of the threshing machine of FIG. 1, showing the clutch means arrangements therefor.

### BEST MODE(S) FOR CARRYING OUT THE INVENTION

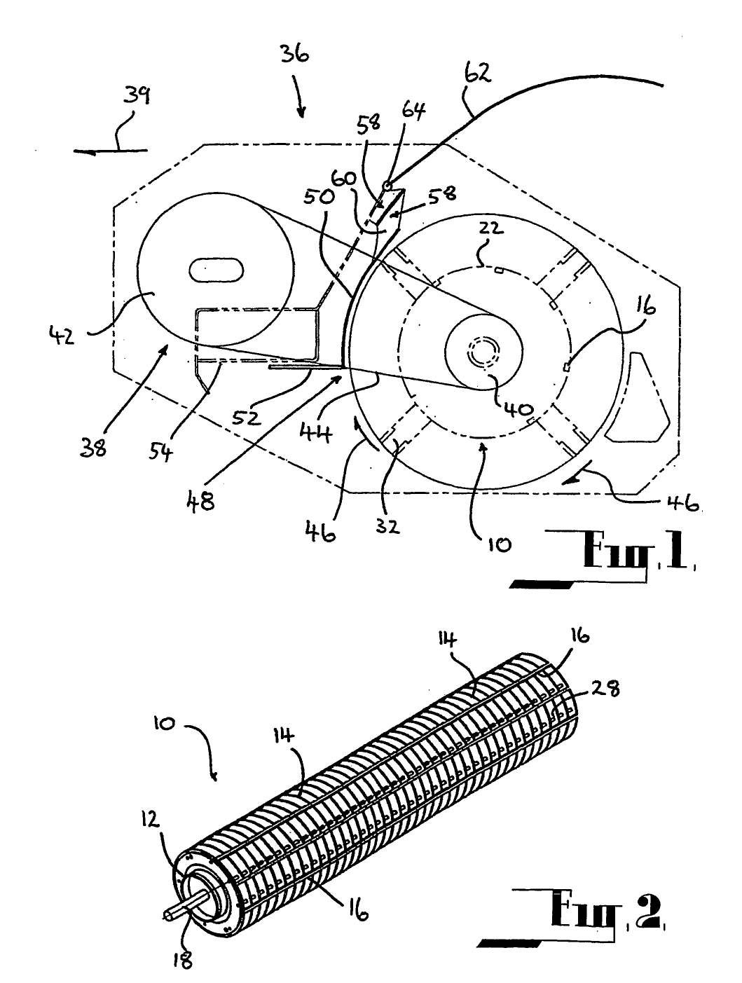

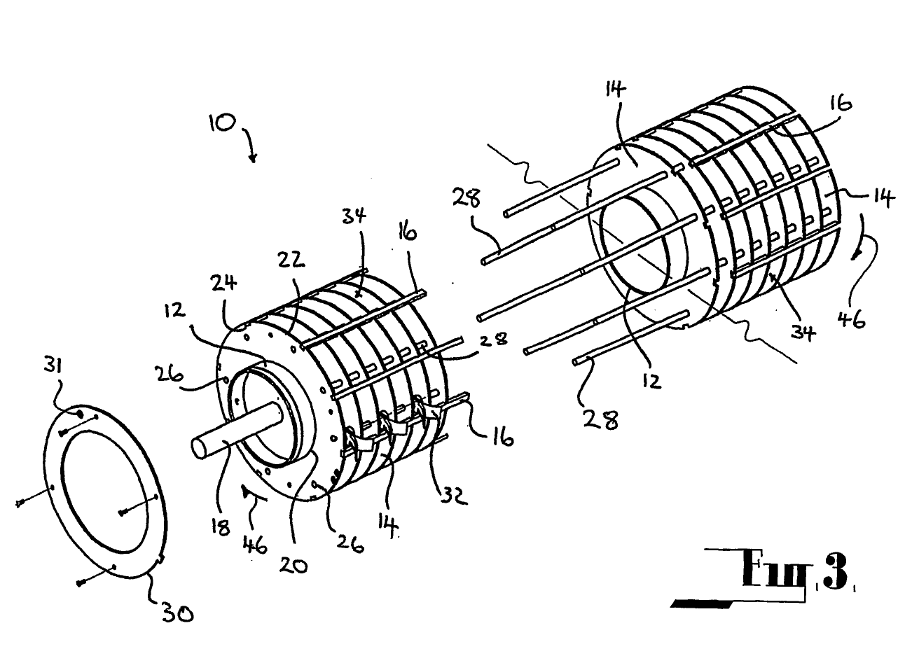

In FIGS. 1, 2, 3 and 8 there is shown an improved thresher rotor 10 comprising a rotor tube 12, a plurality of radially extending annular collars 14, and eight reinforcing bars 16.

The rotor tube 12 has provided at each end thereof an axle arrangement 18 enabling the rotor 10 to be rotatably mounted.

Each annular collar 14 is fixedly attached at an inner edge 20 thereof to the rotor tube 12. Each annular collar 14 similarly has a circular periphery 22, in which are provided eight equally spaced notches 24, through which the reinforcing bars 16 are fixedly attached to provide added strength to the rotor 10.

Further, each annular collar 14 similarly has provided therein a number of equally spaced apertures 26 positioned adjacent the periphery 22 and similarly adjacent the reinforcing bars 16. The apertures 26 of each of the annular collars 14 are arranged such that elongate rods 28 may project therethrough over the length of the rotor 10.

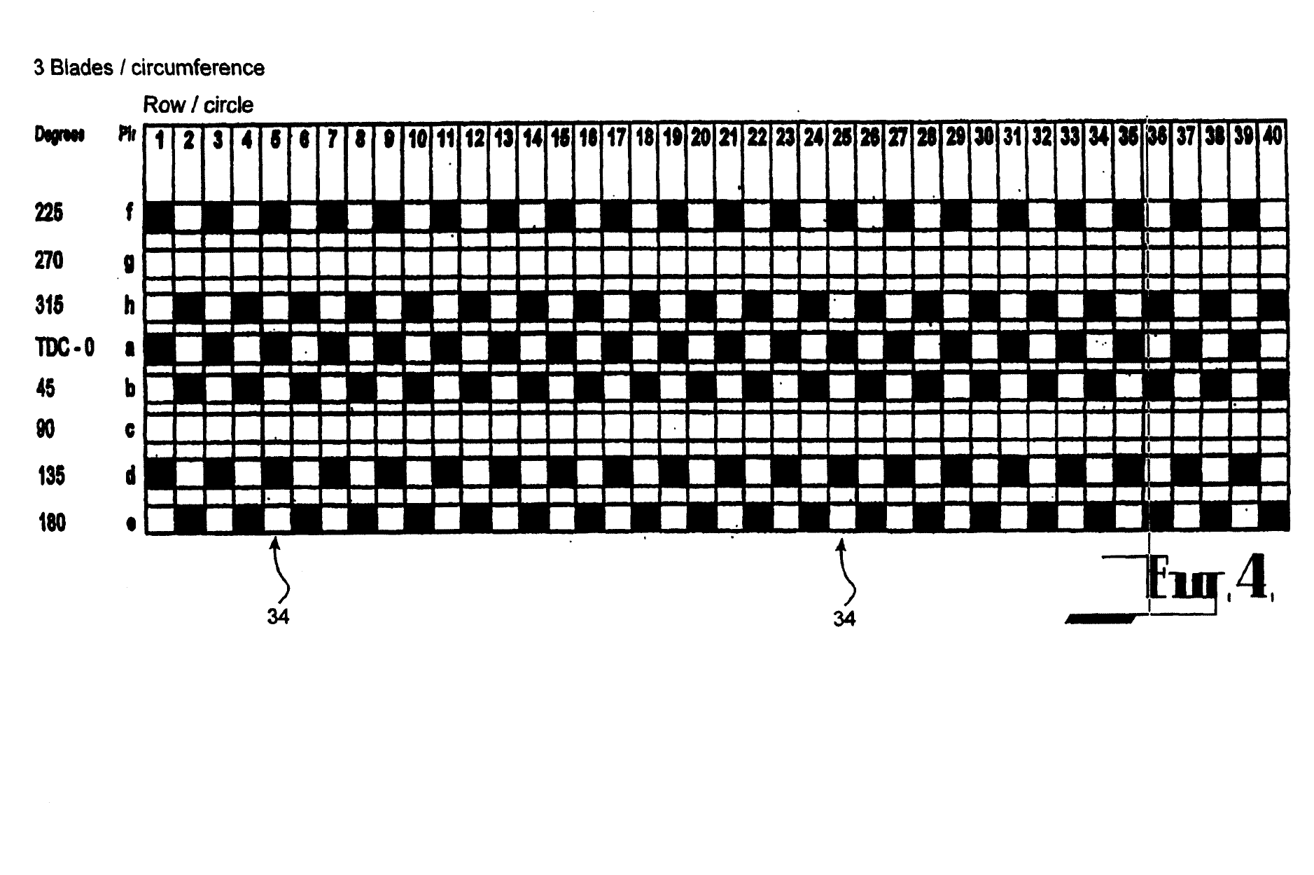

There are provided eight reinforcing bars 16 spaced around the rotor 10 at intervals of 45°. Similarly, there are provided eight elongate rods 28 spaced apart at intervals of 45°. As noted above, the elongate rods 28 are offset radially with respect to the reinforcing bars 16, as is best seen in FIG. 3. Additionally, the reinforcing bars 16 are positioned in rotation ahead of the elongate rods 28.

The elongate rods 28 are located removably through the apertures 26 in the annular collars 14. To facilitate ease of insertion each elongate rod 28 has provided at least one end thereof a chamfer (not shown). Additionally, the other end of each elongate rod 28 is provided with a threaded internal aperture by which a special elongate rod removal and installation tool may be attached. The elongate rods 28 are retained within the annular collars 14 through the action of rod retaining annular plates 30 provided at each end of the rotor 10. The annular plates 30 are releasably attachable to an outer surface of the annular collars 14 at each end of the rotor 10 and have provided therein a single aperture 31. When fixed in position, the annular plate 30 covers the exposed apertures 26, thereby retaining the elongate rods 28 in position through the annular collars 14. When it becomes necessary to remove and insert rods 28 the annular plate 30 is released from the annular collar 14 and rotated to a point at which the aperture 31 is aligned with the rod 28 that is to be removed or the apertures 26 into which the rod 28 is to be inserted.

The elongate rods 28 also function to retain a desired number of blades 32, best seen in FIG. 3, within annular channels 34 formed between the annular collars 14. The blades 32 are of known type and are retained by the elongate rods 28 in a pivotal manner allowing the blades movement about an axis defined by the elongate rod by which it is attached to the rotor 10. The reinforcing bars 16 are positioned forward in rotation with respect to the elongate rods 28 in a manner allowing the reinforcing bars 16 to function as a heel for the blades 32 to rest on preventing clashing of the blades 32 during the commencement of rotation and the cessation of rotation of the rotor 10 when in use.

During use, the blades 32 are extended radially through centrifugal force generated by the rotation of the rotor 10. The pivotal mounting about the elongate rods 28 allows deflection of the blades 32 if heavy loads or foreign objects are encountered by the blades 32 during rotation of the rotor 10. The specific positioning of the reinforcing bars 16 with respect to the elongate rods 28 does not prevent this occurring given the direction of rotation of the rotor 10 when in use.

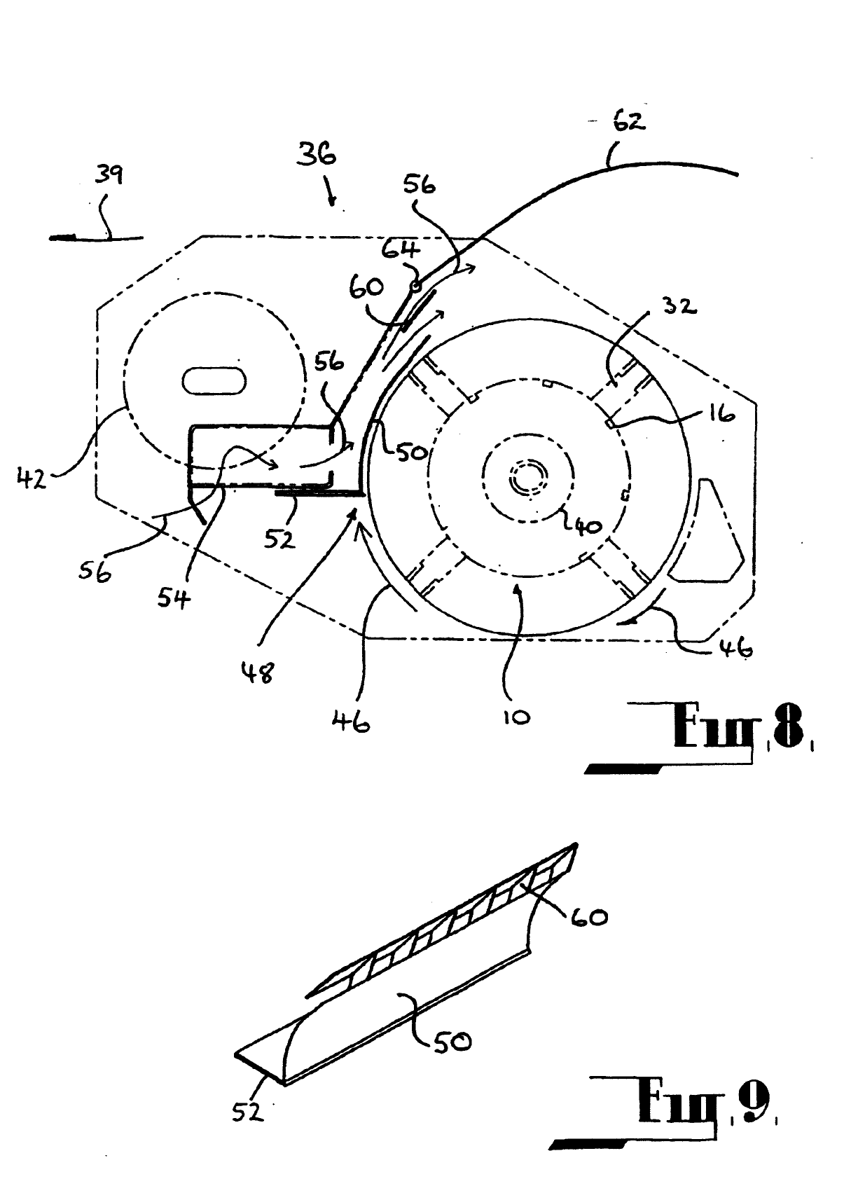

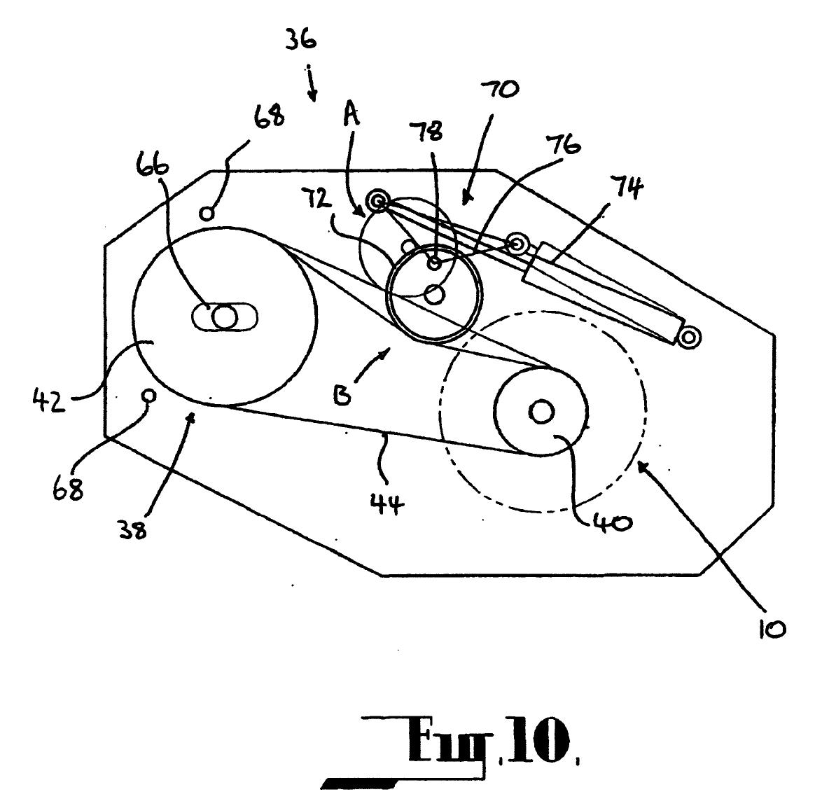

In FIGS. 1 and 8 the rotor 10 is shown in position within a threshing machine 36, the machine 36 providing a rotatable mounting for the rotor 10 together with a drive arrangement 38 by which rotational energy may be transferred to the rotor 10. The machine 36 is adapted for movement in the direction of arrow 39 when in use. The drive arrangement 38 comprises a rotor pulley 40 and a drive pulley 42, about which is provided a belt 44. The rotor 10 is operated at 1800 rpm, although a suitable rotational speed can lie between 1700 rpm and 2000 rpm.

The direction of rotation of the rotor 10 when in use is indicated by arrows 46. The machine 36 further comprises a mulching chamber 48 defined in part by a forward wall 50 and the blades 32 of the rotor 10. The forward wall 50 has provided at a lowermost point thereof a counter-blade 52, the level of the counter-blade 52 being arranged to be slightly below that of the horizontal axis of rotation of the rotor 10, as can be seen from FIGS. 1 and 8.

The forward wall 50 extends upwardly in an arcuate manner maintaining a clearance from an arc described by the blades 32 when extended fully during rotation. Using the blade arrangement of FIG. 5, the inventors have discovered that a clearance during use between the blades 32 and the forward wall 50 of 20 mm is most effective. The forward wall 50 extends upwardly to a point forward of the vertical and about 40° with respect to the horizontal axis of rotation of the rotor 10. It is envisaged that the specific clearance between the forward wall 50 and the blades 32 may be altered depending upon the blade configuration used to achieve best results, as may the point to which the forward wall 50 extends.

An air intake 54 is provided forward of the forward wall 50, the air intake 54 directing airflow into the machine 36 and along a forward face of the forward wall 50 in an upward manner, best seen in FIG. 8, the direction of airflow being indicated by arrows 56. The airflow 56 is then directed through air outlets defined by fins 60 which act to segment the airflow and even the airflow out across the width of the machine 36 creating a venturi effect as mulched or threshed material is expelled freely and efficiently from the mulching chamber 48 so as to project that material away from the machine 36. An upper edge of the forward wall 50 is arranged to extend from the mulching chamber 48 in a substantially tangential manner, thereby contributing to the free movement of mulched material into the venturi airflow.

A pivotal lid 62 is provided on the machine 36, the lid 62 being pivoted about a point 64 located adjacent and above the fins 60. When in operation, the lid 62 is fixed in an up position, as shown in FIGS. 1 and 8, the lid 62 contributing to the effective or free discharge of threshed material from the mulching chamber 48. The interaction of the threshed material with the airflow 56 has significance in preventing double cutting of the mulched or threshed material. The lid 62 may also be partially closed during operation of the machine 36 to direct loose voluminous material to the ground directly behind the machine 36. Additionally, the lid 62 is also an important safety feature. It is envisaged that means, for example fins mounted on the lid, may be provided to direct the threshed material in a direction chosen by the user.

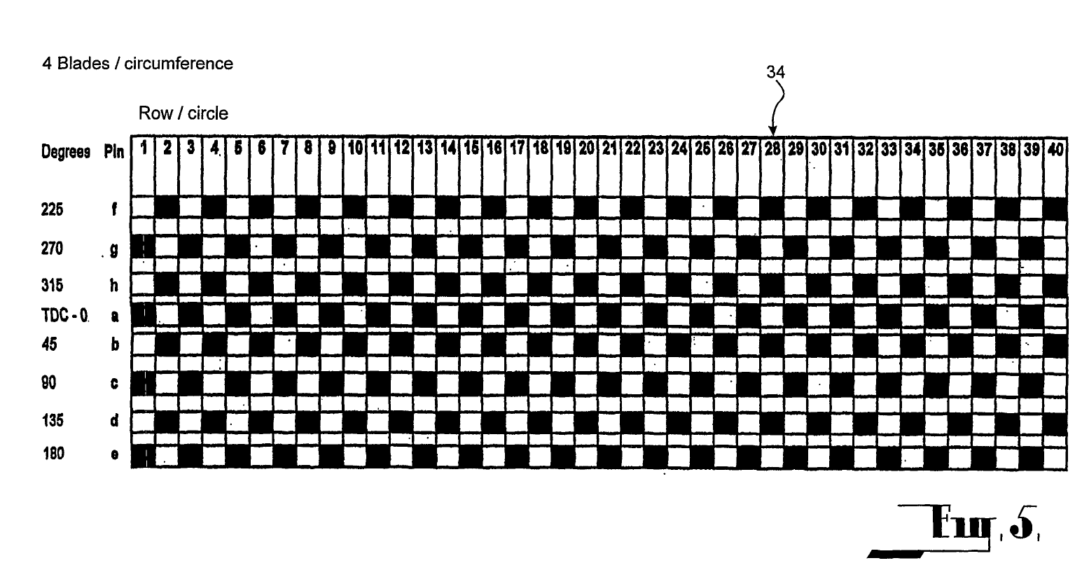

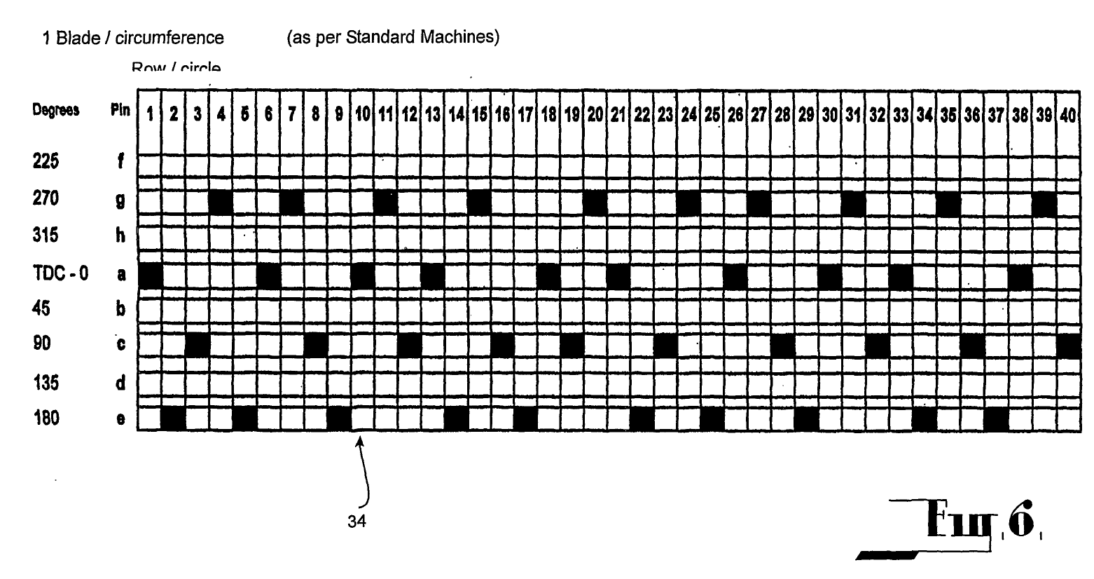

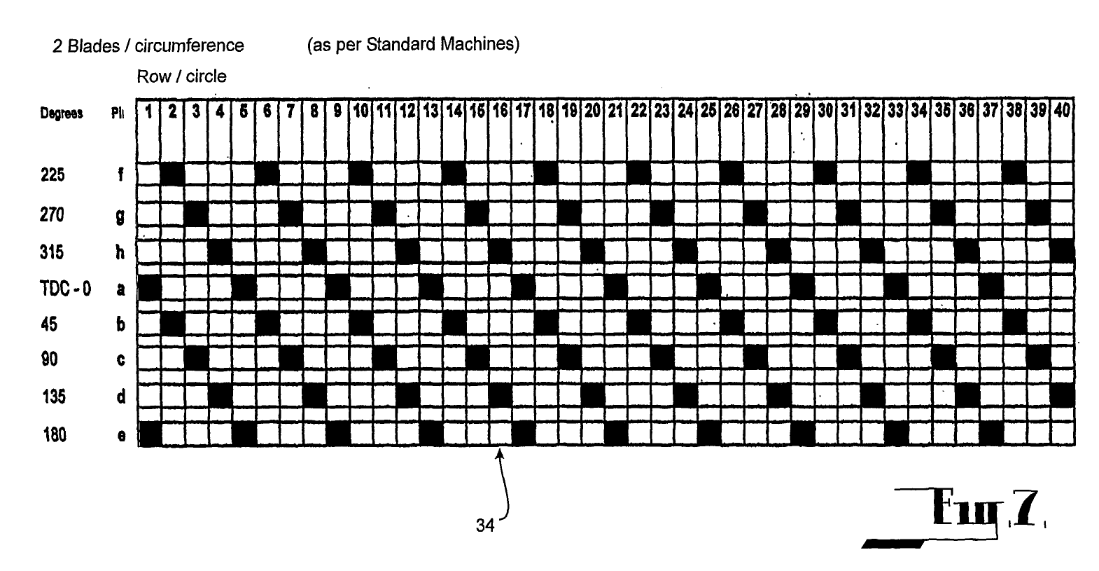

In FIGS. 4 to 7 there are shown a number of optional blade arrangements for the rotor 10. The shaded segments designate the presence of a blade 32. The vertical segments represent the annular channels 34, whilst the horizontal segments represent the elongate rods 28 about which a blade 32 may be located. The inventors have discovered that the arrangement shown in FIG. 5, of four blades 32 per annular channel 34, the blades 32 being equally spaced at 90° intervals thereabout and offset with respect to the blades 32 provided in the adjacent annular channel 34, is most effective. The design of the blades 32 is such that the offset nature of the blades 32 provides eight cuts per revolution of the rotor 10 as the blades 32 overlap to some extent during rotation. However, it is to be understood that the blade arrangement may be altered to suit different users and differing crop and stubble types as seen fit. Fundamentally however, the rotor 10 must remain balanced.

In FIG. 10 there is shown the drive mechanism 38 with the drive pulley 42 and rotor pulley 40 and belt 44. The drive pulley 42 is provided with a means 66 for adjustment of the tension in the belt 44 of substantially known type. In addition, belt retaining pins 68 are located adjacent to the drive pulley 42 to ensure the belt does not leave the pulley 42. A clutch means 70 comprising an idler wheel 72, a hydraulic ram 74 and a link member 76 is provided in a position in which the idler wheel 72 may be cause to impinge on the belt 44, as shown in FIG. 10.

The idler wheel 72 has an idler pivot 78 located thereon and which may be acted upon by the hydraulic ram 74 and link 76 to induce movement in the idler wheel 72. The idler wheel 72 is shown in a disengaged position A in which drive is not imparted to the rotor 10, and in an engaged position B in which drive is passed to the rotor 10. The provision of the clutch means 70 allows the power to drive the rotor 10 to be passed effectively thereto without stalling or damage. The weight of the rotor 10 is such that it may be difficult to induce rotation of the rotor 10 if not achieved through the gradual engaging of the clutch means 70. Further, the weight of the rotor 10 and the speed of its rotation is such that when stopping that rotation this can also lead to damage to the machine 36 and it is envisaged that the clutch means 70 will be similarly utilised in this situation.

The improved thresher rotor of the present invention provides a rotor 10 of substantial rigidity across its length allowing use of high power drives, increased speed of travel of the machine 36 to which it is fitted, increased volumes of materials and increased blade weights. This allows the rotor 10 of the present invention to be used in dense and tough crops and stubble. It has been found by the inventors that the blade arrangement shown in FIG. 5 is most effective in rice stubble and it is envisaged that the rotor 10 will be similarly effective in other traditionally difficult crops and stubbles, including cotton, corn and sugarcane.

The provision of the annular collars 14 about the rotor tube 12 and the specific provision of the removal elongate rods 28 is such that the blade arrangements may be readily altered with minimum disruption to operation and with minimum time wastage. Further, a multitude of blade mounts of prior art type are not necessary. A number of blade mounts of prior art type would result in laborious blade changing and significant addition to the weight of the rotor. Still further, a rotor 10 of far greater effective diameter is provided with the rotor 10 of the present invention.

Modifications and variations such as would be apparent to the skilled addressee are considered to fall within the scope of the present invention.

The claims defining the invention are as follows:

1. A thresher rotor comprising a rotor tube about the length of which is provided a plurality of radially extending annular collars in spaced relationship, adjacent said collars defining therebetween an annular channel, the collars having provided therein apertures through which are provided elongate rods.

2. A thresher rotor as claimed in claim 2 wherein the elongate rods are spaced equidistant around the collars substantially adjacent a periphery thereof.

3. A thresher rotor as claimed in claim 2 or 3 wherein a plurality of reinforcing bars are provided extending across the diameter of the annular collars in a manner offset with respect to the apertures through which are received the elongate rods.

4. A thresher rotor as claimed in any one of the preceding claims wherein the elongate rods have provided thereabout a plurality of blades located in the annular channels between the collars, the blades being retained in a pivotal manner.

5. A thresher rotor as claimed in claim 4 wherein the blades are arranged so that they project radially beyond the periphery of the annular collars.

6. A thresher rotor as claimed in claim 4 or 5 wherein four blades are provided in each said annular channel defined by the collars, the blades being spaced evenly or equidistantly.

7. A thresher rotor as claimed in claim 4, 5, or 6 wherein the blades in adjacent said annular channels are offset by 45°.

8. A thresher rotor as claimed in any one of the preceding claims wherein an annular rod retaining plate is provided at each end of the rotor, releasably attachable to the outermost annular collar so as to capture the rods in their position through the annular collars.

9. A threshing machine comprising in part a thresher rotor as claimed in any one of the preceding claims.

10. A threshing machine as claimed in claim 9 wherein the thresher rotor is provided within a mulching chamber, the mulching chamber having a forward wall comprised in part of a counter-blade provided at a lower edge thereof.

11. A threshing machine as claimed in claim 9 or 10 wherein the forward wall of the mulching chamber maintains a specific and predetermined clearance from the blades of the thresher rotor so as to allow passage of the threshed material therethrough, the forward wall commencing at its lower edge at a point marginally below the axis of the thresher rotor and extending upwardly to a point forward of the vertical relative to that same axis.

12. A threshing machine as claimed in claim 9, 10, or 11 wherein the mulching chamber preferably has provided therein airflow passages projecting from an air intake to a point above the forward wall of the chamber at which point the airflow creates a venturi-flow with threshed material from the mulching chamber to discharge same therefrom.

13. A threshing machine as claimed in any one of claims 9 to 12 wherein the mulching chamber preferably has a lid provided thereover, the lid when open or removed allowing free discharge of threshed material from the mulching chamber to a point clear of the threshing machine.

14. A threshing machine as claimed in any one of claims 9 to 12 wherein further including clutch means for engaging and disengaging drive to the rotor.

15. A thresher rotor substantially as herein described with reference to the drawings.

16. A threshing machine substantially as herein described with reference to the drawings.
